(19) United States
(12) Patent Application Publication
(10) Pub. No.: US 2013/0015713 A1
(43) Pub. Date: Jan. 17, 2013

(54) SYSTEM STABILIZATION SYSTEM, ELECTRIC POWER SUPPLY AND DEMAND ADJUSTMENT DEVICE, CONTROL DEVICE FOR ELECTRIC POWER SUPPLY AND DEMAND ADJUSTMENT DEVICE, ELECTRIC POWER SUPPLY AND DEMAND ADJUSTMENT METHOD, AND ELECTRIC POWER SUPPLY AND DEMAND ADJUSTMENT METHOD USING STORAGE BATTERY

(71) Applicant: Ryuzo Hagihara, Moriguchi City (JP)

(72) Inventor: Ryuzo Hagihara, Moriguchi City (JP)

(73) Assignee: SANYO ELECTRIC CO., LTD., Moriguchi City, Osaka (JP)

(21) Appl. No.: 13/637,703

(22) PCT Filed: Mar. 18, 2011
(86) PCT No.: PCT/JP2011/056619

§ 371 Date: Sep. 27, 2012

(30) Foreign Application Priority Data
Mar. 30, 2010 (JP) 2010-078180

(51) Int. Cl. H02J 3/32

(52) U.S. Cl. 307/72

(57) ABSTRACT

The system stabilization system includes an electric power supply and demand management device possessing supply and demand situation information related to the supply and demand of electric power in at least a portion of a power grid, and an electric power supply and demand adjustment device acquiring the supply and demand situation information and performing an electric power supply and demand adjustment by at least accepting electric power from the power grid or supplying electric power to the power grid. The electric power supply and demand adjustment device is configured so as to make a determination regarding an electric power supply and demand adjustment on the basis of the acquired supply and demand situation information.

### FIELD OF THE INVENTION

The present invention relates to a system stabilization system, an electric power supply and demand adjustment device, a control device for the electric power supply and demand adjustment device, an electric power supply and demand adjustment method, and an electric power supply and demand adjustment method using a storage battery.

### BACKGROUND

Stabilization systems connected to a power grid are known to include a supply and demand adjustment device that is able to make adjustments to the supply and demand of electric power. An example of such a system stabilization system is disclosed in Laid-Open Patent Publication No. 2003-284244.

In the system stabilization system disclosed in Laid-Open Patent Publication No. 2003-284244, a rechargeable battery (electric power supply and demand adjustment device) and a rechargeable battery control system for issuing charge and discharge instructions to the rechargeable battery are installed at a consumer site. A system control system (electric power supply and demand management device) is also installed in a central supply and demand control office. This system stabilization system is configured so that discharge instructions can be issued from the system control system in the central supply and demand control office to the rechargeable battery control system in each consumer site when the supply of electric power to the power grid is significantly lower than demand. In this way, supply and demand can be adjusted in a power grid using rechargeable batteries at consumer sites.

### SUMMARY

A purpose of the present invention is to provide a system stabilization system, an electric power supply and demand adjustment device, a control device for the electric power supply and demand adjustment device, an electric power supply and demand adjustment method, and an electric power supply and demand adjustment method using a storage battery which are able to adjust supply and demand in a power grid without having to install a mechanism for authenticating electric power supply and demand adjustment devices and also while being able to reduce the control burden on the electric power supply and demand management device.

In order to achieve this purpose, the present invention is a system stabilization system including an electric power supply and demand management device possessing supply and demand situation information related to the supply and demand of electric power in at least a portion of a power grid, and an electric power supply and demand adjustment device acquiring the supply and demand situation information and performing an electric power supply and demand adjustment by at least accepting electric power from the power grid or supplying electric power to the power grid. In this system, the electric power supply and demand adjustment device is configured so as to make a determination regarding an electric power supply and demand adjustment on the basis of the acquired supply and demand situation information.

The present invention is also an electric power supply and demand adjustment device including an electric power supply and demand adjusting unit either accepting electric power from a power grid or supplying electric power to the power grid, an information acquiring unit acquiring supply and demand situation information related to the electric power supply and demand situation in at least a portion of the power grid, and a control unit acquiring the supply and demand situation information in the information acquiring unit, and making a determination regarding an electric power supply and demand adjustment on the basis of the supply and demand situation information.

The present invention is also a control device for an electric power supply and demand adjustment device making an electric power supply and demand adjustment by either accepting electric power from a power grid or supplying power to the power grid, in which the control device includes a control device being able to acquire supply and demand situation information related to the supply and demand situation for electric power in at least a portion of the power grid. This control unit is configured so as to make a determination with respect to an electric power supply and demand adjustment in at least a portion of the power grid on the basis of the acquired supply and demand situation information.

The present invention is also a method performing a supply and demand adjustment in a power grid, in which the electric power supply and demand adjustment method includes the steps of publicly disclosing on a website an amount of electric power supplied per unit of time, publicly disclosing on the website an amount of electric power demanded per unit of time, requesting a charge or discharge from an electric power supply and demand adjustment device to charge or discharge electric power in response to an electric power supply and demand situation, updating and publicly disclosing on the website the amount of electric power supplied and the amount of electric power demanded on the basis of notification data from a responding electric power supply and demand adjustment device, and verifying the electric power supply and demand situation after the charge or discharge of electric power by the electric power supply and demand adjustment device.

The present invention is also a method performing a supply and demand adjustment in a power grid using a storage battery, in which the electric power supply and demand adjustment method using a storage battery includes the steps of adjusting the capacity of the storage battery to a predetermined value, checking the dischargeable capacity and chargeable capacity of the storage battery, holding supply and demand situation information on the power grid, accessing a server configured to make electric power discharge or charge requests, and checking the request situation for the charging or discharging of electric power, comparing the dischargeable or chargeable capacity to the requested discharge or charge amount to determine whether the request can be met, notifying the server of information regarding the electric power to be supply-and-demand adjusted when the determination step was successful, and performing a charge or discharge according to the information regarding the electric power to be supply-and-demand adjusted.

In the present invention, the supply and demand situation information of the electric power supply and demand management device can be acquired by electric power supply and demand adjustment devices even when charge/discharge instructions have not been received from the electric power supply and demand management device. The supply and demand situation in the power grid can be determined and electric power supply and demand adjustments made by the electric power supply and demand adjustment devices themselves. Because charge/discharge instructions do not have to be issued individually by the electric power supply and demand management device to each electric power supply and demand adjustment device, the electric power supply and demand management device does not have to acquire and manage information (fixed IP address, etc.) identifying each electric power supply and demand adjustment device, and a mechanism for authenticating electric power supply and demand adjustment devices does not have to be installed. Also, because each electric power supply and demand adjustment device makes decisions related to supply and demand adjustments by itself, each electric power supply and demand adjustment device only has to grasp its own chargeable or dischargeable capacity. The electric power supply and demand management device does not have to monitor the status of each electric power supply and demand adjustment device. In this way, supply and demand in a power grid can be adjusted without having to install a mechanism for authenticating electric power supply and demand adjustment devices and also while being able to reduce the control burden on the electric power supply and demand management device.

### BRIEF DESCRIPTION OF THE DRAWINGS

FIG. 1 is a conceptual diagram showing a system stabilization system according to a first embodiment of the present invention;

FIG. 2 is a flowchart used to explain the operational flow of an electric power supply and demand managing device in a system stabilization system according to a first embodiment of the present invention;

FIG. 3 is a flowchart used to explain the operational flow of an electric power supply and demand adjustment device in a system stabilization system according to a first embodiment of the present invention; and

FIG. 4 is a conceptual diagram showing a system stabilization system according to a second embodiment of the present invention.

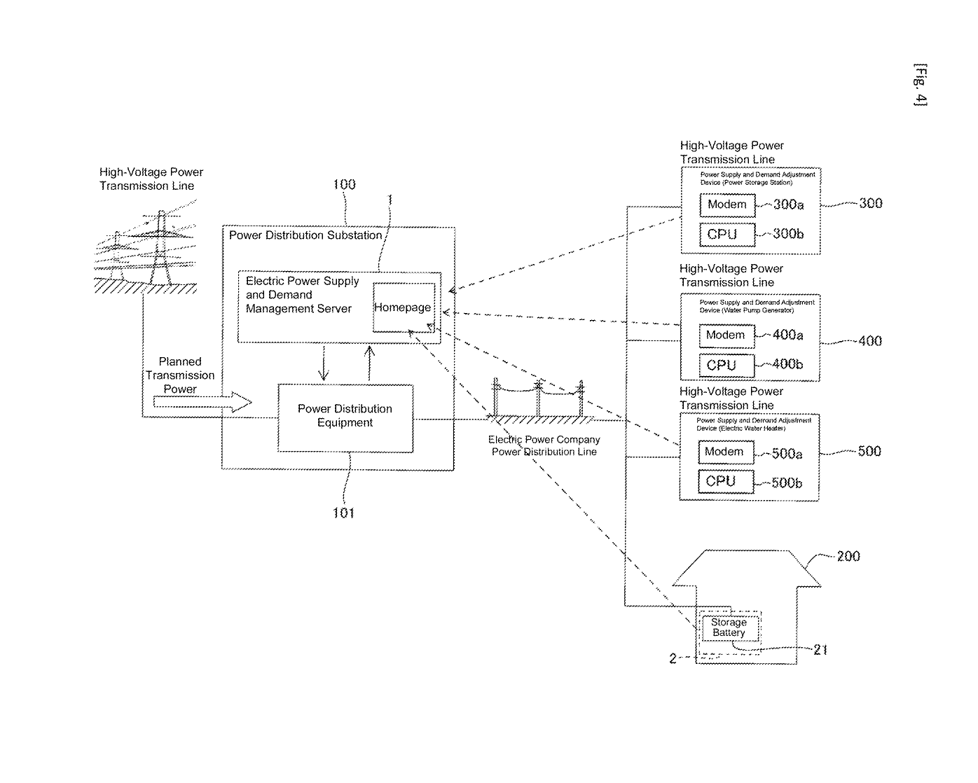

### DETAILED DESCRIPTION

The following is an explanation of embodiments of the present invention with reference to the drawings.

### 1st Embodiment

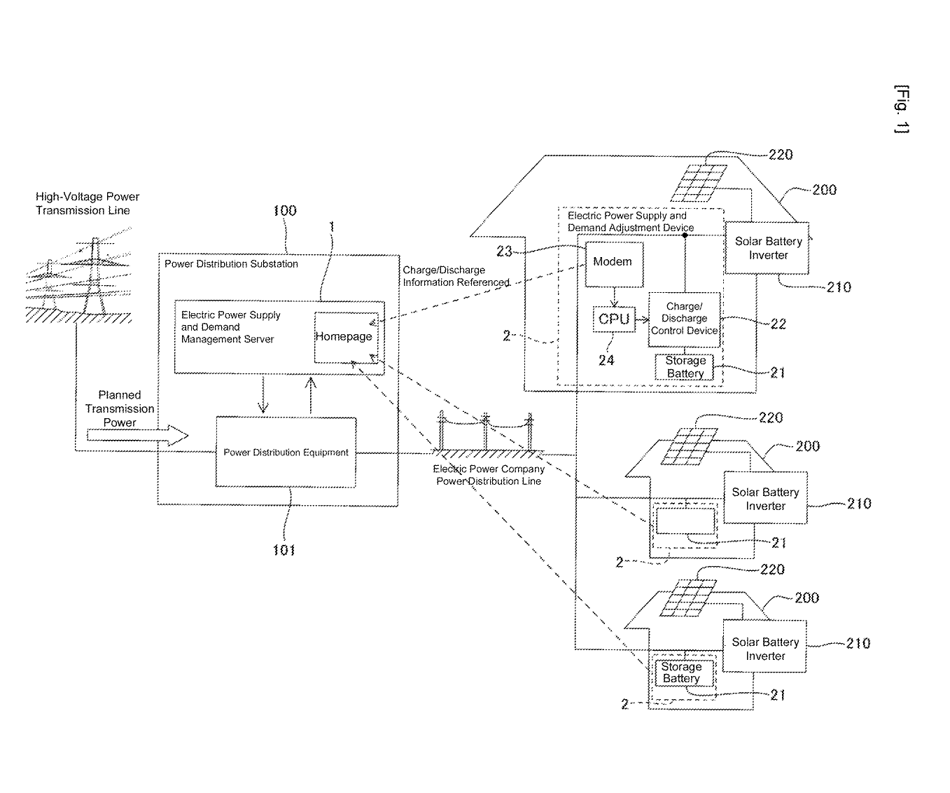

First, the flow of electric power in a general power grid will be explained with reference to FIG. 1. Electric power generated at a power plant is distributed to a plurality of power distribution substations 100 via high-voltage power transmission lines, and is then distributed from the power distribution substations 100 to consumer sites 200 such as houses, factories and other installations via the distribution lines of the power company. Power distribution equipment 101, such as a transformer for converting electric power supplied at high voltage to a low voltage for supply to consumer sites, is installed in the power distribution substations 100. At the power distribution substations 100, the supply and demand balance between power distributed from the power plant (planned transmission power) and power consumed at consumer sites 200 is monitored.

The following is an explanation of the configuration of the system stabilization system according to a first embodiment of the present invention with reference to FIG. 1. In the explanation of the first embodiment, a solar cell 220 and a storage battery 21 connected to the power grid via a solar cell inverter 210 are installed in the consumer sites 200.

The system stabilization system of the first embodiment is a system for balancing the supply and demand of electric power in a power grid. The system stabilization system includes an electric power supply and demand management server 1 installed in a power distribution substation 100 for managing the electric power supply and demand situation in the power distribution substation 100, and a plurality of electric power supply and demand adjustment devices 2 installed at consumer sites 200. The electric power supply and demand management server 1 is an example of an “electric power supply and demand management device” in the present invention. Each electric power supply and demand adjustment device 2 includes the storage battery 21 installed in the consumer site 200. When an imbalance occurs in the electric power supply and demand situation in the power grid, the electric power supply and demand adjustment device 2 can charge or discharge the storage battery 21 in response to the imbalance in the supply and demand situation in order to eliminate the imbalance. This is explained in greater detail below.

The electric power supply and demand management server 1 publicly discloses on an internet homepage (website) electric power supply and demand situation information at the power distribution substation 100 acquired from the power distribution equipment 101. The electric power supply and demand management server 1 acquires supply and demand situation information and updates the publicly disclosed information on the homepage at a predetermined time interval (for example, every 30 seconds). The publicly disclosed supply and demand information includes data on the amount of planned transmission power (amount of power supplied) at every predetermined time interval (30 seconds) for the past hour, and data on the amount of distributed power (amount of power demanded) at every predetermined time interval (30 seconds) for the past hour.

Also, the electric power supply and demand management server 1 determines whether or not there is a supply and demand imbalance between the amount of power supplied and the amount of power demanded, and, when a supply and demand imbalance has occurred, requests the acceptance of electric power or the supply of electric power. In other words, when demand for electric power is less than the supply, the electric power supply and demand management server 1 determines that there is a surplus of electric power, and requests that available electric power supply and demand adjustment devices 2 (electric power supply and demand adjustment devices 2 with storage batteries 21 having surplus charge capacity) accept at least some of the surplus electric power. When demand for electric power is greater than the supply, the electric power supply and demand management server 1 determines that there is a deficit of electric power, and requests that available electric power supply and demand adjustment devices 2 (electric power supply and demand adjustment devices 2 with storage batteries 21 having surplus discharge capacity) supply at least some of the deficit in electric power.

When an electric power supply and demand adjustment device 2 has responded to a request for supply and demand adjustment, the electric power supply and demand management server 1 corrects the publicly disclosed information on the basis of notification information from the electric power supply and demand adjustment device 2. The notification information from the electric power supply and demand adjustment device 2 includes data on the amount of power adjusted by the electric power supply and demand adjustment device 2 responding to the request (charged power or discharged power), and data on the time of the adjustment.

An electric power supply and demand adjustment device 2 primarily includes a charge/discharge control device 22 for controlling the charging or discharging of the storage battery 21, a modem 23 for accessing the homepage of the electric power supply and demand management server 1, and a CPU 24 for controlling the modem 23 and the charge/discharge control device 22. The charge/discharge control device 22 includes an AC/DC converter. The modem 23, storage battery 21 and CPU 24 are examples, respectively, of the “information acquiring unit”, the “electric power supply and demand adjusting unit” and the “control unit” in the present invention. The storage battery 21 is an example of a “storage device” of the present invention.

The CPU 24 is configured to monitor the charge status of the storage battery 21, and periodically access the homepage of the electric power supply and demand management server 1 to acquire publicly disclosed information (supply and demand situation information) and, if present, requests for supply and demand adjustment. When there is a request for a supply and demand adjustment, the CPU 24 determines whether or not it can respond to the request based on the request details (charge request or discharge request) and the charge status of the storage battery 21. When it has determined that it can respond to the request, the CPU 24 determines the amount of adjusted power and the adjustment time (referred to below as the adjustment details), and notifies the electric power supply and demand management server 1 of the determined adjustment details via the homepage. The CPU 24 then performs charging or discharging of the storage battery 21 in accordance with the adjustment details.

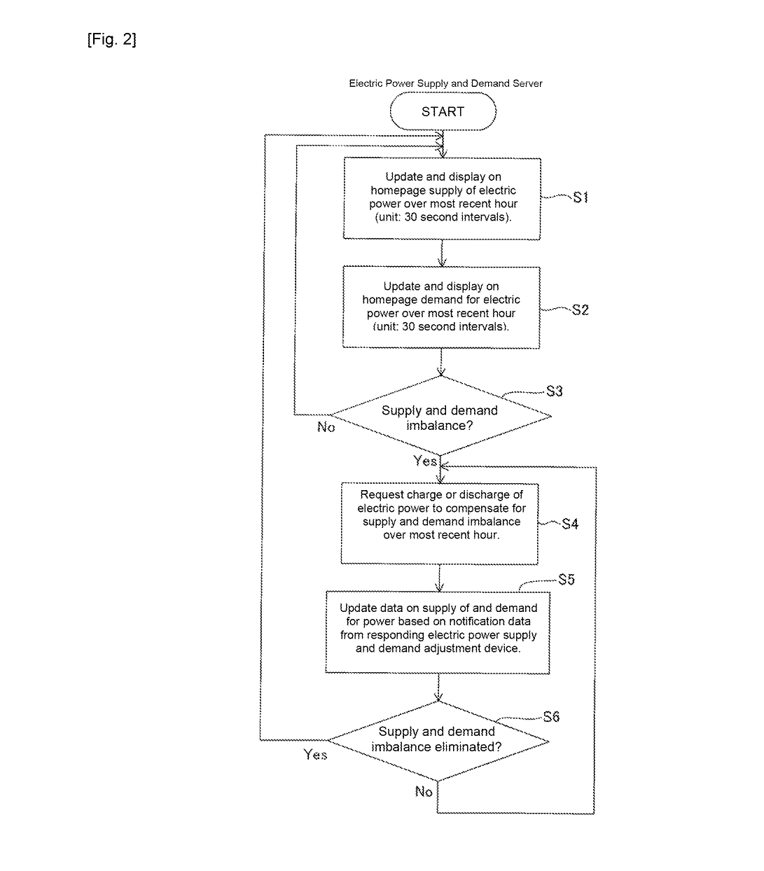

The following is an explanation with reference to FIG. 2 of the control flow of the electric power supply and demand management server 1 in the system stabilization system of the first embodiment of the present invention.

First, in Step S1, the electric power supply and demand management server 1 updates and displays the amount of planned transmission power (amount of power supplied) over the past hour on the homepage (website) of the electric power supply and demand management server 1. Next, in Step S2, the electric power supply and demand management server 1 updates and displays the amount of distributed power (amount of power demanded) over the past hour.

Then, in Step S3, the electric power supply and demand management server 1 determines whether or not there has been a supply and demand imbalance over the past hour. If there has been no imbalance, the process returns to Step S1, and the electric power supply and demand management server 1 repeats Step S1 through Step S3. If there is an imbalance, the electric power supply and demand management server 1 in Step S4 requests a charge or discharge on the homepage to compensate for the supply and demand imbalance. Here, an electric power supply and demand adjustment device 2 responds as described below when it is able to charge or discharge power in accordance with the request.

In Step S5, the electric power supply and demand management server 1 updates data on the amount of power supplied and the amount of power demanded publicly disclosed on the homepage on the basis of notification data including adjustment details from responding electric power supply and demand adjustment devices 2 (adjusted power amount data and adjustment time data from the responding electric power supply and demand adjustment devices 2). Next, in Step S6, the electric power supply and demand management server 1 determines whether or not the imbalance in electric power supply and demand has been eliminated. When the imbalance has been eliminated, the electric power supply and demand management server 1 ends the request on the homepage, and the process returns to Step S1. When the imbalance has not been eliminated, the process returns to Step S4, and the electric power supply and demand management server 1 continues the request on the homepage until the imbalance has been eliminated.

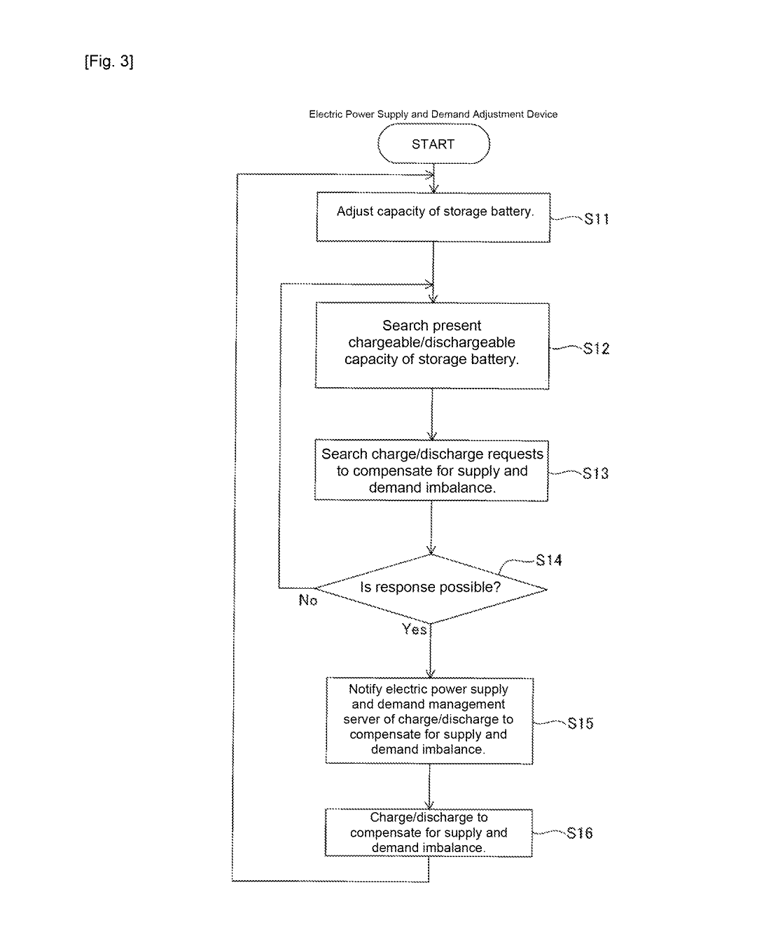

The following is an explanation with reference to FIG. 3 of the control flow of an electric power supply and demand adjustment device 2 in the system stabilization system according to the first embodiment of the present invention.

First, in Step S11, the electric power supply and demand adjustment device 2 adjusts the capacity of the storage battery 21. More specifically, the electric power supply and demand adjustment device 2 adjusts the capacity to ½ charged in order to be able to both charge and discharge. The adjustment in capacity is performed at a time when there are no sharp fluctuations in power generated by the solar cells 220 such as late at night. Next, in Step S12, the electric power supply and demand adjustment device 2 searches (checks) the current dischargeable capacity and chargeable capacity of its own storage battery 21.

Then, in Step S13, the electric power supply and demand adjustment device 2 accesses the homepage of the electric power supply and demand management server 1 to search (check) for a charge/discharge request to compensate for any supply and demand imbalance. In Step S14, the electric power supply and demand adjustment device 2 determines whether or not it can respond to the charge/discharge request to compensate for the supply and demand imbalance. In other words, the electric power supply and demand adjustment device 2 determines whether or not it can perform the requested charge or discharge on the basis of its own dischargeable capacity and chargeable capacity and on the requested charge or discharge.

When it has determined that it cannot respond, the process returns to Step S12, and the electric power supply and demand adjustment device 2 repeats the search of its own chargeable capacity and dischargeable capacity and the search for a charge/discharge request from the power distribution substation 100.

When it has determined that is can respond, the electric power supply and demand adjustment device 2 in Step S15 notifies the electric power supply and demand management server 1 via the homepage of the amount of its own charge or discharge and the time of the charge or discharge. In Step S16 after the notification, the electric power supply and demand adjustment device 2 charges or discharges the notified amount at the notified time. Afterwards, the process returns to Step S11, and the electric power supply and demand adjustment device 2 repeats Step S11 through Step S16.

In the first embodiment, the processing from Step S11 to Step S16 is performed by the electric power supply and demand adjustment devices 2 at an entire consumer site 200 over which a power distribution substation 100 has jurisdiction. Because each of the electric power supply and demand adjustment devices 2 operates to adjust a supply and demand imbalance, the supply and demand is adjusted by each of the electric power supply and demand adjustment devices 2 until the supply and demand imbalance has been eliminated.

Because of this configuration, the system stabilization system in the first embodiment can obtain the following advantageous effects.

In other words, each electric power supply and demand adjustment device 2 is configured so as to be able to obtain supply and demand situation information from an electric power supply and demand management server 1, and make a determination regarding an electric power supply and demand adjustment on the basis of the supply and demand situation information from the electric power supply and demand management server 1. In this configuration, the electric power supply and demand adjustment device 2 can obtain supply and demand situation information from the electric power supply and demand management server 1, and the electric power supply and demand adjustment device 2 itself can make a determination on the supply and demand situation in the power grid and make an electric power supply and demand adjustment, even when the electric power supply and demand adjustment device 2 does not receive a charge/discharge instruction from the electric power supply and demand management server 1. Because the electric power supply and demand management server 1 does not have to issue charge/discharge instructions individually to each electric power supply and demand adjustment device 2, the electric power supply and demand management server 1 does not have to obtain and manage information identifying each electric power supply and demand adjustment device 2 (fixed IP addresses, etc.), and a mechanism for authenticating electric power supply and demand adjustment devices 2 is not required. Because each electric power supply and demand adjustment device 2 makes its own decision regarding a supply and demand adjustment, each electric power supply and demand adjustment device 2 only has to grasp its own chargeability/dischargeability. The electric power supply and demand management server 1 does not have to monitor the status of each electric power supply and demand adjustment device 2. Thus, a mechanism for authenticating electric power supply and demand adjustment devices 2 is not required, and electric power supply and demand adjustments can be made while reducing the control load of the electric power supply and demand management server 1.

Also, the storage battery 21 installed at a consumer site 200 for power can be used as an electric power supply and demand adjustment device 2. In this configuration, supply and demand adjustments can be made which effectively utilize the equipment at the consumer site 200, and new equipment such as a power storage substation does not have to be installed by the power company.

By using a storage battery 21 as the electric power supply and demand adjustment device 2, a supply and demand imbalance can be eliminated by charging the storage battery 21 when there is surplus power in the power grid. A supply and demand imbalance can also be eliminated by discharging power from the storage battery 21 when there is a power deficit in the power grid. In this way, a supply and demand imbalance can be easily eliminated.

Also, each electric power supply and demand adjustment device 2 is configured to notify the electric power supply and demand management server 1 of information related to supply-and-demand adjusting power when an electric power supply and demand adjustment is to be made. In this configuration, the electric power supply and demand management server 1 can readily grasp the supply and demand adjustment situation.

Also, the electric power supply and demand management server 1 is configured to correct the supply and demand situation information on the basis of notification information provided by electric power supply and demand adjustment devices 2. In this configuration, the requested supply-and-demand adjusting power can be reduced each time an electric power supply and demand adjustment device 2 makes a supply and demand adjustment. In this way, the necessary and sufficient electric power can be reliably adjusted by the electric power supply and demand adjustment devices 2.

Also, each electric power supply and demand adjustment device 2 is configured to periodically access the homepage of the electric power supply and demand management server 1 to obtain supply and demand situation information. In this way, supply and demand adjustments based on supply and demand situation information different from the actual supply and demand situation can be reduced.

Also, the electric power supply and demand management server 1 is configured to publicly disclose supply and demand situation information on a website, and the electric power supply and demand adjustment devices 2 are configured to access the website and acquire the supply and demand situation information. In this way, electric power supply and demand adjustment devices 2 can easily obtain supply and demand situation information via the internet. Also, because the electric power supply and demand management server 1 only has to publicly disclose supply and demand situation information on its own homepage (website), the control burden on the electric power supply and demand management server 1 can be reduced.

### 2nd Embodiment

The following is an explanation of a system stabilization system according to the second embodiment of the present invention. In the explanation of the second embodiment, unlike the first embodiment, a device other than a storage battery 21 is used as an electric power supply and demand adjustment device.

In the second embodiment, a storage battery 21 at a consumer site 200 not equipped with a photovoltaic installation (solar cells 220 and solar cell inverter 210) and devices other than the storage battery 21 are used as an electric power supply and demand adjustment device. The devices other than a storage battery 21 used as electric power supply and demand adjustment devices are a power storage station 300, a water pump generator 400 and an electric water heater 500. The power storage station 300, water pump generator 400 and electric water heater 500, like the electric power supply and demand adjustment device 2, include modems 300a, 400a and 500a for accessing the homepage (website) of an electric power supply and demand management server 1 and acquiring supply and demand situation information, and CPUs 300b, 400b and 500b for making a decision regarding a supply and demand adjustment on the basis of the acquired supply and demand situation information.

The operations related to supply and demand adjustments of the power storage station 300 are similar to those of the electric power supply and demand adjustment device 2. When there is a power surplus in the power grid, the water pump generator 400 accepts and uses surplus power, for example, to pump water from a lower reservoir to an upper reservoir. When a deficit of power occurs in the power grid, the pumped water can be allowed to fall in order to generate electric power, and the electric power can be supplied to the power grid. An electric water heater 500 cannot generate and supply electric power. However, when there is a power surplus in the power grid, the surplus power can be accepted and used to make hot water.

As in the electric power supply and demand adjustment device 2, the CPUs 300b, 400b and 500b in each device periodically access the homepage (website) of the electric power supply and demand management server 1, and determine on their own whether they can accept or supply electric power. Also, when there is a supply and demand adjustment request from the electric power supply and demand management server 1, the CPUs 300b, 400b and 500b in each device respond if they can perform the requested supply and demand adjustment by notifying the electric power supply and demand management server 1 of the adjustment details, and then execute a supply and demand adjustment according to the adjustment details.

The rest of the configuration in the second embodiment is similar to that of the first embodiment.

The effects of the second embodiment are similar to those of the first embodiment.

The disclosed embodiments are for illustrative purposes only and are not intended to be limiting in any way. The scope of the invention is indicated by the scope of the claims and not by the explanation of the embodiments, and includes meanings equivalent to the scope of the claims, and all modifications within the scope.

For example, in the first and second embodiments, a storage battery 21 was used as an example of a storage device. However, the present invention is not limited to this example. A capacitor can be used, for example, instead of the storage battery.

Also, in the explanation of the first and second embodiments, the supply and demand situation of a power distribution substation 100 forming a part of the power grid is publicly disclosed on a homepage, and any imbalance in the supply and demand situation is eliminated. However, the present invention is not limited to this. For example, in the present invention, the supply and demand situation for the entire power grid (amount of planned generator power, etc.) can be publicly disclosed by the central dispatching office of the power company, so that any imbalance in the supply and demand situation of the entire power grid can be eliminated.

Also, in the first and second embodiments, examples of electric power supply and demand adjustment devices able to both accept electric power from the power grid and supply electric power to the power grid included a storage battery, power storage station, and water pump generator. Also, an electric water heater was provided as an example of an electric power supply and demand adjustment device able to accept electric power from the power grid. However, the present invention is not limited to these. For example, any load other than an electric water heater can be used as an example of an electric power supply and demand adjustment device able to accept electric power from the power grid. Also, any generator able to supply electric power to the power grid is an example of an electric power supply and demand adjustment device able to supply electric power to the power grid.

In the explanation of the first and second embodiments, the electric power supply and demand adjustment device accesses the homepage (website) of the electric power supply and demand management server 1 to acquire supply and demand situation information publicly disclosed on the homepage. However, the present invention is not limited to these embodiments. For example, the electric power supply and demand management server 1 can deliver (publicly disclose) the supply and demand situation information to electric power supply and demand adjustment devices via the internet or the airwaves.

In the explanation of the first and second embodiments, the electric power supply and demand management server 1 determines whether an electric power imbalance has occurred, and requests a supply and demand adjustment when an imbalance has occurred. However, the present invention is not limited to these embodiments. For example, the electric power supply and demand management server 1 can simply disclose the supply and demand situation information without requesting a supply and demand adjustment, and the electric power supply and demand adjustment devices can determine whether or not there is an imbalance.

In the explanation of the first and second embodiments, the electric power supply and demand management server 1 was installed in a power distribution substation 100. However, the present invention is not limited to these embodiments. It can be installed somewhere other than a power distribution substation 100.

What is claimed is:

1. A system stabilization system comprising: an electric power supply and demand management device possessing supply and demand situation information related to the supply and demand of electric power in at least a portion of a power grid;
and an electric power supply and demand adjustment device configured to acquire the supply and demand situation information and to perform an electric power supply and demand adjustment by at least one of accepting electric power from the power grid and supplying electric power to the power grid;
the electric power supply and demand adjustment device is configured to make a determination regarding an electric power supply and demand adjustment on the basis of the acquired supply and demand situation information.

2. The system stabilization system of claim 1, wherein the electric power supply and demand adjustment device is installed at a consumer site for electric power or at a power storage station, and is configured to access supply and demand situation information in the electric power supply and demand management device from the consumer site for electric power or from the power storage station, and acquire the supply and demand situation information.

3. The system stabilization system of claim 1, wherein the electric power supply and demand adjustment device comprises:
an information acquiring unit configured to access and require supply and demand situation information in the power supply and demand management device;
an electric power supply and demand adjusting unit configured to perform at least one of accepting electric power from the power grid and supplying electric power to the power grid; and
a control unit configured to control the information acquiring unit so that the supply and demand situation information is acquired, to make a determination regarding an electric power supply and demand adjustment on the basis of the supply and demand situation information, and to control the electric power supply and demand adjusting unit so that a supply and demand adjustment is performed on the basis of the results of the determination.

4. The system stabilization system of claim 1, wherein the electric power supply and demand management device publicly discloses the supply and demand situation information, and the electric power supply and demand adjustment device is configured to acquire the supply and demand situation information publicly disclosed by the electric power supply and demand management device.

5. The system stabilization system of claim 4, wherein the electric power supply and demand management device is configured to request an electric power supply and demand adjustment when there is an electric power supply and demand imbalance and to end the request for an electric power supply and demand adjustment when the electric power supply and demand imbalance has been eliminated, and wherein the electric power supply and demand adjustment device is configured to respond to the request for a supply and demand adjustment when an electric power supply and demand adjustment is to be performed.

6. The system stabilization system of claim 5, wherein the electric power supply and demand management device is configured to determine whether or not an electric power supply and demand imbalance has occurred on the basis of the supply of electric power and the demand for electric power in at least a portion of the power grid over a predetermined period of time just prior to the present time.

7. An electric power supply and demand adjustment device comprising:
an electric power supply and demand adjusting unit configured to perform an electric power supply and demand adjustment by at least one of accepting electric power from a power grid and supplying electric power to the power grid;
an information acquiring unit configured to acquire supply and demand situation information related to the electric power supply and demand situation in at least a portion of the power grid; and
a control unit configured to control the information acquiring unit so that the supply and demand situation information is acquired, and that a determination regarding an electric power supply and demand adjustment is performed on the basis of the supply and demand situation information.

8. The electric power supply and demand adjustment device of claim 7, wherein the electric power supply and demand adjusting unit includes a power storage device, and
wherein the control unit is configured to charge the power storage device with at least a portion of the surplus power in the power grid when there is less demand for electric power than supply of electric power in the power grid, and to discharge at least a portion of the power deficit in the power grid from the power storage device to the power grid when the demand for electric power is greater than the supply of electric power in the power grid, on the basis of the acquired supply and demand situation information.

9. The electric power supply and demand adjustment device of claim 8, wherein the control unit is configured to determine whether or not an electric power supply and demand adjustment is to be made on the basis of the acquired supply and demand situation information, and at least one of the chargeable capacity and dischargeable capacity of the power storage device.

10. The electric power supply and demand adjustment device of claim 7, wherein the information acquiring unit is configured to output information related to the electric power to be supply-and-demand adjusted when an electric power supply and demand adjustment is performed.

11. The electric power supply and demand adjustment device of claim 10, wherein the information related to the electric power to be supply-and-demand adjusted includes data on the amount of power to be supply-and-demand adjusted, and data on the time of the supply and demand adjustment.

12. The electric power supply and demand adjustment device of claim 7, wherein the supply and demand situation information includes data on the amount of power supplied by and the amount of power demanded from at least a portion of the power grid.

13. A control device for an electric power supply and demand adjustment device making an electric power supply and demand adjustment by at least one of accepting electric power from a power grid and supplying power to the power grid,
the control device comprising a control unit configured to acquire supply and demand situation information related to the supply and demand situation for electric power in at least a portion of the power grid,
the control unit is configured to make a determination with respect to an electric power supply and demand adjustment in at least a portion of the power grid on the basis of the acquired supply and demand situation information.

14. The control device for an electric power supply and demand adjustment device of claim 13, wherein the control unit is configured to make a determination regarding an electric power supply and demand adjustment on the basis of the supply and demand situation information, and to make an electric power supply and demand adjustment on the basis of the results of the determination.

15. The control device for an electric power supply and demand adjustment device of claim 14, wherein the control unit is configured to output information related to the electric power to be supply-and-demand adjusted by the electric power supply and demand adjustment device when an electric power supply and demand adjustment is performed.

16. A method performing a supply and demand adjustment in a power grid, the electric power supply and demand adjustment method comprising the steps of:
publicly disclosing on a website an amount of electric power supplied per unit of time;
publicly disclosing on the website an amount of electric power demanded per unit of time;
requesting a charge or discharge from an electric power supply and demand adjustment device to charge or discharge electric power in response to an electric power supply and demand situation;
updating and publicly disclosing on the website the amount of electric power supplied and the amount of electric power demanded on the basis of notification data from a responding electric power supply and demand adjustment device;
and verifying the electric power supply and demand situation after the charge or discharge of electric power by the electric power supply and demand adjustment device.

17. A method performing a supply and demand adjustment in a power grid using a storage battery, the electric power supply and demand adjustment method using a storage battery comprising the steps of:
adjusting the capacity of the storage battery to a predetermined value;
checking the dischargeable capacity and chargeable capacity of the storage battery;
holding supply and demand situation information on the power grid, accessing a server configured to make electric power discharge or charge requests, and checking the request situation for the charging or discharging of electric power;
comparing the dischargeable or chargeable capacity to the requested discharge or charge amount to determine whether the request can be met;
notifying the server of information regarding the electric power to be supply-and-demand adjusted when the determination step was successful; and
performing a charge or discharge according to the information regarding the electric power to be supply-and-demand adjusted.
